(19) United States
(12) Patent Application Publication
(10) Pub. No.: US 2005/0264709 A1
(43) Pub. Date: Dec. 1, 2005

(54) CRT receiver, high-definition CRT receiver and digital broadcasting CRT receiver

(75) Inventors: Takayuki Kado, Takefu-city (JP); Katsushi Yamashita, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/140,247

(22) Filed: May 31, 2005

(30) Foreign Application Priority Data
May 31, 2004 (JP) 2004-161711

(51) Int. Cl. H04N 5/64

(52) U.S. Cl. 348/836

(57) ABSTRACT

It is an object of the present invention to provide a television receiver using a cathode ray tube capable of reducing development and manufacturing costs during a period of transition from analog television to digital television. By forming functional sections common to CRT display devices such as a video signal processing section made up of a chroma section 505, horizontal drive circuit section 506 and vertical drive circuit section 508, a power supply section 503 and fly-back transformer 507 on a TV printed circuit board 50 as a circuit board different from a circuit board provided with functional sections for generating a video signal from each broadcasting signal or the like, and replacing only non-common parts (parts of the separate circuit board), it is possible to construct analog television and digital television, and reduce development and manufacturing costs.

The present application is based on and claims priority of Japanese patent applications No. 2004-161711 filed on May 31, 2004, the entire contents of which are hereby incorporated by reference.

### BACKGROUND OF THE INVENTION

1. Field of the Invention

The present invention relates to a television receiver using acathode ray tube, and more particularly, to a television receiver whose circuit board is shared between a receiver with a built-in analog broadcasting receiving device and a receiver with a built-in digital broadcasting receiving device.

2. Description of the Related Art

In recent years, digital satellite broadcasting and digital cable television broadcasting are being provided and transition to a digital system is under way in ground-based broadcasting as well. Therefore, development and manufacturing of a television receiver (hereinafter simply referred to as “digital television”) capable of receiving digital broadcasting are being stepped up and efforts are naturally under way to reduce development and manufacturing costs of digital television and a digital broadcasting receiving device incorporated in digital television.

As one of methods for reducing the development and manufacturing costs of such a device, a circuit board provided inside the device is designed with commonality or shared among a plurality of models and such conventional technologies related to digital television are disclosed in Japanese Patent Publication No. 2000-165761, Japanese Patent Publication No. 2000-299576 and Japanese Patent Publication No. 2003-61009 (Patent Documents 1 to 3) or the like.

As described above, digitization of broadcasting is under way, while there are also countries or regions which are scheduled to continue broadcasting based on an analog system for the time being (with no specific digitization in view). Therefore, the time may come when only digital television sets are produced in the future, but manufacturing of television receivers capable of receiving analog broadcasting (hereinafter simply referred to as “analog television”) will continue for the time being and it is expected that transition from analog television to digital television will take place step by step in accordance with the progress of digitization of broadcasting and the trend of the market (e.g., transition will take place from devices capable of receiving only analog broadcasting to those capable of receiving both analog broadcasting and digital broadcasting and finally transition will take place to devices capable of receiving only digital broadcasting). On the contrary, the conventional technologies disclosed in Japanese Patent Publication No. 2000-165761, Japanese Patent Publication No. 2000-299576 and Japanese Patent Publication No. 2003-61009 (Patent Documents 1 to 3) or the like are mainly applicable to only digital television and not applicable to both analog television and digital television in the process of transition from analog television to digital television.

In view of the above described situation, it is an object of the present invention to provide a television receiver using a cathode ray tube capable of reducing development and manufacturing costs in the process of transition from analog television to digital television.

### SUMMARY OF THE INVENTION

A CRT receiver according to a first aspect of the invention is a CRT receiver which receives/displays analog broadcasting or digital broadcasting, comprising a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television, and in the case of a receiver which receives analog broadcasting, an AV printed circuit board made up of one or a plurality of circuit boards including a video signal conversion section which generates the video signal from an analog broadcasting signal and a audio signal processing section which generates the audio signal from an analog broadcasting signal as a separate circuit board or in the case of a receiver which receives digital broadcasting, an AV printed circuit board made up of one or a plurality of circuit boards including a video signal conversion section which generates the video signal from a digital broadcasting signal and a audio signal processing section which generates the audio signal from a digital broadcasting signal as a separate circuit board.

According to the above described structure, a TV printed circuit board can be shared between a CRT receiver which receives/displays analog broadcasting and a CRT receiver which receives/displays digital broadcasting.

A high-definition CRT receiver according to a second aspect of the invention is a CRT receiver which receives/displays analog broadcasting or digital broadcasting, comprising a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television, and an AV printed circuit board made up of one or a plurality of circuit boards including a video signal conversion section which generates the video signal from an analog broadcasting signal and a audio signal processing section which generates the audio signal from an analog broadcasting signal as a separate circuit board.

According to the above described structure, a circuit board (AV printed circuit board) provided with a function of generating a video signal and audio signal from an analog broadcasting signal and a circuit board (TV printed circuit board) provided with a function of generating an RGB signal input from the video signal to the CRT circuit board and amplifying the audio signal are formed as separate circuit boards.

A high-definition CRT receiver according to a third aspect of the invention is a CRT receiver which receives/displays analog broadcasting or digital broadcasting, comprising a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television, and an AV printed circuit board made up of one or a plurality of circuit boards including a digital video signal conversion section which generates the video signal from a digital broadcasting signal and a digital audio signal processing section which generates the audio signal from a digital broadcasting signal as a separate circuit board.

According to the above described structure, a circuit board (AV printed circuit board) provided with a function of generating a video signal and audio signal from a digital broadcasting signal and a circuit board (TV printed circuit board) provided with a function of generating an RGB signal input from the video signal to the CRT circuit board and amplifying the audio signal are formed as separate circuit boards.

The high-definition CRT receiver or digital broadcasting CRT receiver according to a fourth aspect of the invention is the high-definition CRT receiver according to the first aspect or the digital broadcasting CRT receiver according to the second aspect of the invention, wherein the video signal processing section comprises at least, a chroma section, a horizontal drive circuit section and a vertical drive circuit section and the TV printed circuit board comprises an operation section provided with operation buttons and remote control light-receiving section or the like, and an external input terminal section.

According to the above described structure, the video signal processing section, sound amplifier section, power supply section, fly-back transformer, operation section and external input terminal section are formed on the TV printed circuit board and the TV printed circuit board is shared between the high-definition CRT receiver and digital broadcasting CRT receiver.

The high-definition CRT receiver according to a fifth aspect of the invention is the high-definition CRT receiver according to the first or third aspect of the invention, wherein the video signal conversion section comprises at least an analog tuner device, a 3D Y/C separation section, an I/P conversion section, a scaler section and a control section, the audio signal processing section comprises at least the analog tuner device, a sound multiplexing section, a sound processor section and the control section and the AV printed circuit board comprises an AV switch section, an A/D converter section and an external input/output terminal section.

The digital broadcasting CRT receiver according to a sixth aspect of the invention is the digital broadcasting CRT receiver according to the second or third aspect of the invention, wherein the digital video signal conversion section comprises at least, a digital tuner device, an information compression/expansion section and a control section, the digital sound processing section comprises at least the digital tuner device, the information compression/expansion section, a sound processor section and the control section and the AV printed circuit board comprises an AV switch section and an external input/output terminal section.

According to the high-definition CRT receiver according to the second aspect of the invention is a CRT receiver which receives/displays analog broadcasting or digital broadcasting, a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television, and an AV printed circuit board made up of one or a plurality of circuit boards including a video signal conversion section which generates the video signal from an analog broadcasting signal and a audio signal processing section which generates the audio signal from an analog broadcasting signal as a separate circuit board, a circuit board (AV printed circuit board) provided with a function of generating a video signal and audio signal from an analog broadcasting signal and a circuit board (TV printed circuit board) provided with a function of generating an RGB signal input from the video signal to the CRT circuit board and amplifying the audio signal are formed as separate circuit boards, and therefore it is possible to reduce development and manufacturing costs of products during a period of transition from analog television to digital television and reduce development and manufacturing costs of product groups having different functions and grades. That is, the function of displaying video from a video signal (e.g., color-difference signal having 1080i effective scanning lines) on the CRT display tube and power supply section or the like, are common to analog television and digital television, and with the common functional section separated from other functional sections as a separate circuit board, it is possible to switch between analog television and digital television and provide products of different grades by simply replacing non-common functional sections (AV printed circuit board) (e.g., by only developing/manufacturing various AV printed circuit boards such as an AV printed circuit board which generates a video signal and audio signal from a digital broadcasting signal, an AV printed circuit board having a circuit which improves image quality and sound quality when generating the video signal and audio signal from the analog broadcasting signal, an AV printed circuit board having no circuit which improves image quality and sound quality, it is possible to provide products according to the respective specifications).

According to the high-definition CRT receiver or digital broadcasting CRT receiver according to the fourth aspect of the invention, which is the high-definition CRT receiver according to the first or the digital broadcasting CRT receiver according to the second aspect of the invention, wherein the video signal processing section comprises at least, a chroma section, a horizontal drive circuit section and a vertical drive circuit section and the TV printed circuit board comprises an operation section provided with operation buttons and remote control light-receiving section or the like and an external input terminal section, the video signal processing section, sound amplifier section, power supply section, fly-back transformer, operation section and external input terminal section are formed on the TV printed circuit board and the TV printed circuit board is shared between the high-definition CRT receiver and digital broadcasting CRT receiver, and therefore there are more common parts and it is possible to reduce development and manufacturing costs during a period of transition from analog television to digital television and reduce development and manufacturing costs of product groups of different functions (grades).

### BRIEF DESCRIPTION OF THE DRAWINGS

FIG. 1 is a perspective view showing a high-definition CRT receiver according to Embodiment 1;

FIG. 2 is an exploded perspective view showing the high-definition CRT receiver according to Embodiment 1;

FIG. 3 is a partial through-view of the high-definition CRT receiver according to Embodiment 1; a: a top view, b: a front view and c: a side view;

FIG. 4 is a block diagram showing a schematic structure of the AV printed circuit board of Embodiment 1;

FIG. 5 is a block diagram showing a schematic structure of the TV printed circuit board of Embodiment 1;

FIG. 6 is a perspective view showing a digital broadcasting CRT receiver according to Embodiment 2;

FIG. 7 is an exploded perspective view showing the digital broadcasting CRT receiver according to Embodiment 2;

FIG. 8 is a partial through-view of the high-definition CRT receiver according to Embodiment 2; a: a top view, b: a front view and c: a side view;

FIG. 9 is a block diagram showing a schematic structure of the AV printed circuit board according to Embodiment 2; and

FIG. 10 is a plan view showing the CRT circuit board 17.

### DETAILED DESCRIPTION OF THE PREFERRED EMBODIMENTS

With reference now to the attached drawings, specific embodiments of the present invention will be explained below. The following embodiments are only examples when implementing the present invention and not intended to limit the present invention to within the scope thereof.

### Embodiment 1

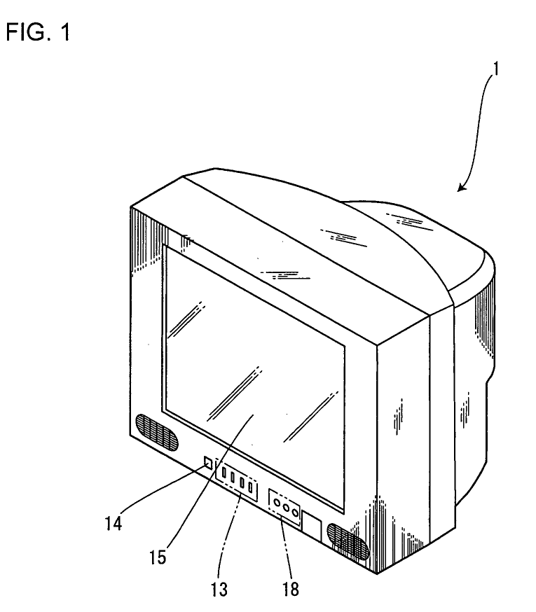

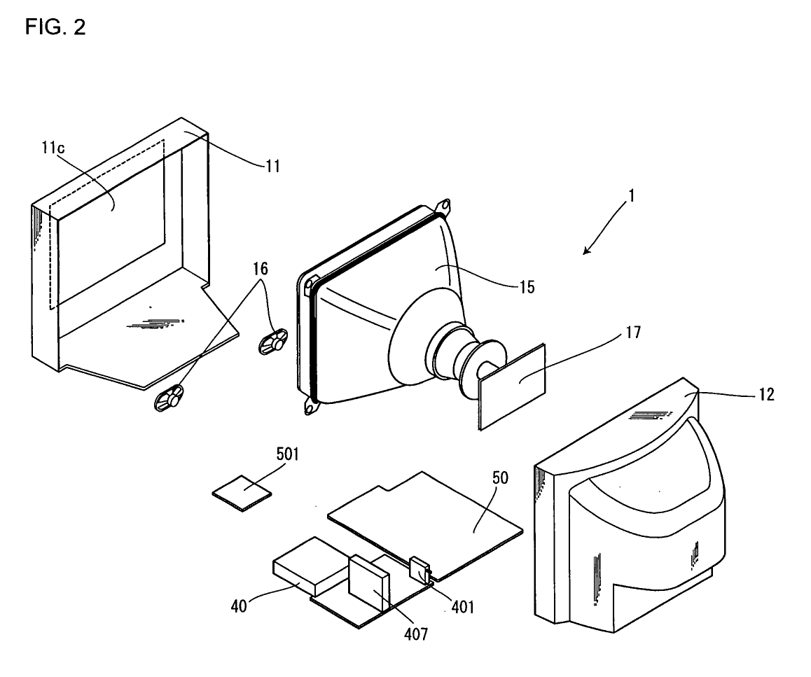

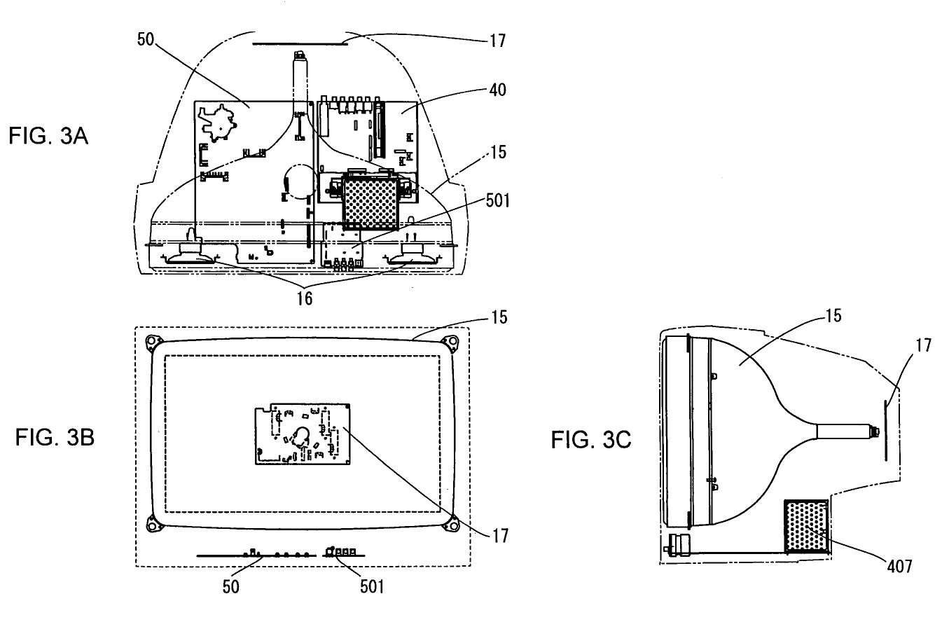

FIG. 1 is a perspective view showing a high-definition CRT receiver according to this embodiment, FIG. 2 and FIG. 3 show a schematic structure of the high-definition CRT receiver; FIG. 2 is an exploded perspective view and FIG. 3 is a partial through-view; a: a top view, b: a front view and c: a side view. Though shown in a simplified form in the figures, each printed circuit board is mounted with various electronic/electric parts and the respective printed circuit boards are mutually electrically connected and input/output various signals.

As shown in FIG. 1 to FIG. 3, the high-definition CRT receiver 1 of this embodiment (hereinafter simply referred to as “CRT receiver 1”) is made up of a CRT display tube 15, a TV printed circuit board 50, an AV printed circuit board 40, a speakers 16 or the like, inside a housing made up of a front cabinet 11 and a rear cabinet 12. The front cabinet 11 having an opening/window section 11c houses the CRT display tube 15 with its video display area exposed by the opening/window section 11c and the AV printed circuit board 40 and the TV printed circuit board 50 are placed at the bottom of the front cabinet 11 and the speakers 16 are placed on both sides of the front cabinet 11 in consideration of acoustic effects. Furthermore, the CRT display tube 15 is connected to a CRT circuit board 17 provided with a circuit which amplifies and outputs an RGB signal from the TV printed circuit board 50. The high-definition CRT receiver 1 of this embodiment has 1080i effective scanning lines.

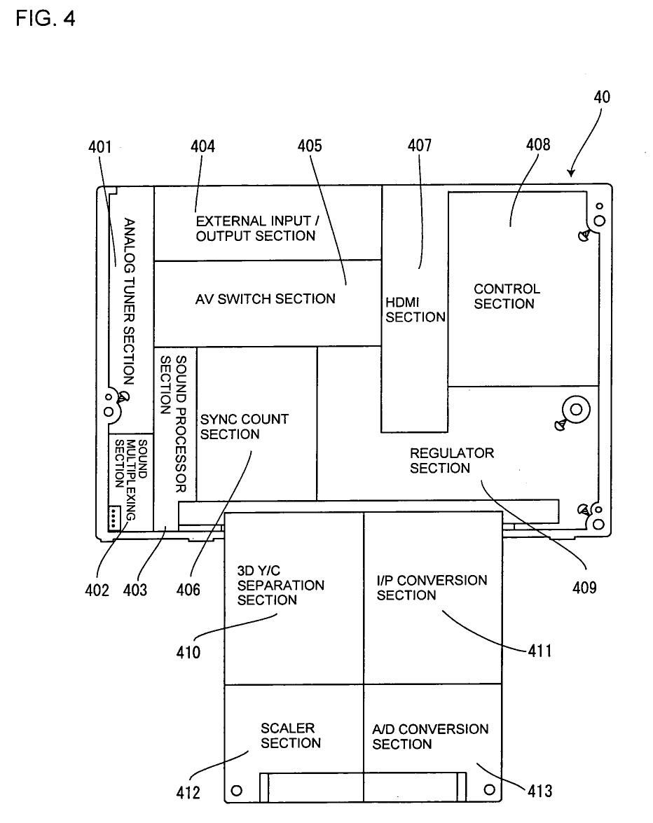

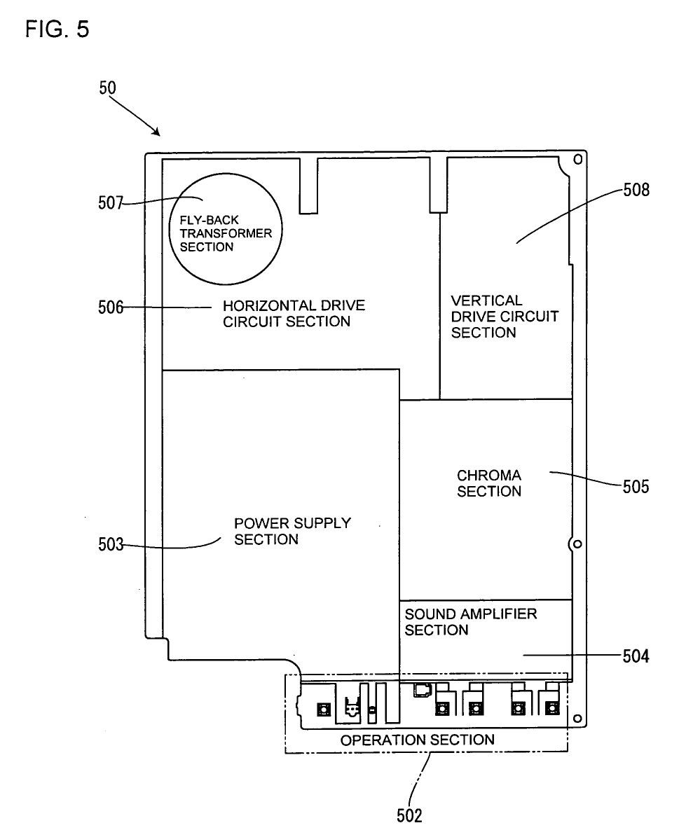

FIG. 4 is a block diagram showing a schematic structure of the AV printed circuit board 40 and FIG. 5 is a block diagram showing a schematic structure of the TV printed circuit board 50. The AV printed circuit board 40 (see FIG. 4) is provided with an analog tuner section 401, a sound multiplexing section 402, a sound processor section 403, an external input/output section 404, an AV switch section 405, a SYNC count section 406, an HDMI section 407, a control section 408, a regulator section 409, a 3D Y/C separation section 410, an I/P conversion section 411, a scaler section 412 and an A/D converter section 413. The TV printed circuit board 50 (see FIG. 5) is provided with an operation section 502, a power supply section 503, a sound amplifier section 504, a chroma section 505, a horizontal drive circuit section 506, a fly-back transformer 507 and a vertical drive circuit section 508. A circuit board 501 is a circuit board provided with an external input/output terminal and designed to form an input/output terminal section 18 at the bottom front of the CRT receiver 1.

An overview of the operation of the AV printed circuit board 40 when an analog broadcasting signal is received will be explained. The analog tuner section 401 converts an analog broadcasting signal input to a video intermediate frequency signal (hereinafter referred to as “video IF signal”) and sound intermediate frequency signal (hereinafter referred to as “sound IF signal”) and a composite video signal is extracted from the video IF signal. The composite video signal is introduced into the 3D Y/C separation section 410 through the AV switch section 405 (which selects either one of an external input signal or a signal from the tuner), where a color-difference signal separated into a brightness signal and chrominance signal is created. The color-difference signal is subjected to a display system conversion and an effective scanning line number conversion by the I/P conversion section 411 (since the CRT receiver 1 of this embodiment has 1080i effective scanning lines, when, for example, broadcasting with 480i effective scanning lines is received, it is converted to 1080i) and then converted to a color-difference signal having 1080i effective scanning lines adjusted to the screen display mode (according to the aspect ratio) by the scaler section 412. On the other hand, the sound IF signal is subjected to a decision as to whether stereo sound is bilingual sound or not by the sound multiplexing section 402 and a demodulated audio signal is created according to the decision. The demodulated audio signal is subjected to signal processing such as sound quality adjustment and stereophonic effect by the sound processor section 403 and converted to a audio signal to be input to a sound amplifier. The operations of the above described functional sections are controlled by the control section 408. Thus, the analog broadcasting signal is converted to a color-difference signal having 1080i effective scanning lines by the analog tuner section 401, 3D Y/C separation section 410, I/P conversion section 411, scaler section 412 and control section 408 which constitute the video signal conversion section of the AV printed circuit board 40, converted to a audio signal to be input to a sound amplifier by the analog tuner section 401, sound multiplexing section 402, sound processor section 403 and control section 408 which constitute the audio signal processing section and input to the TV printed circuit board 50.

An overview of the operation of the AV printed circuit board 40 when a digital high image quality signal is input from the external input terminal section 404 will be explained. The HDMI section 407 converts a digital high image quality signal input to an analog high image quality video signal and an analog audio signal. The analog high image quality video signal is input to the SYNC count section 406 through the AV switch section 405 (either one of an external input signal or a signal from the tuner is selected), where the signal format type is decided and converted to a digital high image quality video signal by the A/D converter section 413. Next, the digital high image quality video signal is subjected to a display system conversion (when the input signal is a progressive display (sequential scanning) system, it is converted to an interlace display (interlaced scanning) system by the I/P conversion section 411, and then converted to a color-difference signal having 1080i effective scanning lines by the scaler section 412 according to the screen display mode (according to the aspect ratio). On the other hand, the analog audio signal is subjected to signal processing such as sound quality adjustment and stereophonic effects by the sound processor section 403 and a audio signal to be input to a sound amplifier is created. The operations of the above described functional sections are controlled by the control section 408. Thus, the digital high image quality signal is converted to a color-difference signal having 1080i effective scanning lines by the HDMI section 407, SYNC count section 406, A/D converter section 413, I/P conversion section 411, scaler section 412 and control section 408 which constitute the video signal conversion section of the AV printed circuit board 40, converted to a audio signal to be input to a sound amplifier by the sound processor section 403 and control section 408 which constitute the audio signal processing section and input to the TV printed circuit board 50.

Next, an overview of the operation of the TV printed circuit board 50 to which the color-difference signal having 1080i effective scanning lines and audio signal to be input to a sound amplifier is input from the AV printed circuit board 40 will be explained. The chroma section 505 creates an RGB signal by carrying out brightness adjustment, light-dark adjustment, color adjustment, matrix processing or the like on the input color-difference signal having 1080i effective scanning lines and extracts a horizontal sync signal and vertical sync signal from the input color-difference signal having 1080i effective scanning lines. From the horizontal sync signal and vertical sync signal, the horizontal drive circuit section 506 and vertical drive circuit section 508 create a horizontal deflection output signal and vertical deflection output signal respectively for deflecting electron beams of the CRT display tube 15 in synchronization with the color-difference signal having 1080i effective scanning lines. By connecting the horizontal deflection output signal and vertical deflection output signal to a deflection coil (not shown) attached to the CRT display tube 15 as an integral part, electron beams of the CRT display tube 15 are deflected and an RGB signal is displayed on the screen of the CRT display tube 15.

As shown above, the RGB signal created by the chroma section 505, horizontal drive circuit section 506 and vertical drive circuit section 508 which constitute the video signal processing section is amplified by the CRT circuit board 17, displayed on the CRT display tube 15 and the audio signal to be input to a sound amplifier input from the AV printed circuit board 40 is amplified by the sound amplifier section 504 of the TV printed circuit board 50 and output from the speakers 16. The operation section 502 provided on the TV printed circuit board 50 is a block provided with an operation section 13 and a remote control light-receiving section 14, the fly-back transformer 507 is a device which generates a high voltage to be supplied to the CRT display tube 15 and the power supply section 503 supplies power to the entire device of the CRT receiver 1. The regulator section 409 provided on the AV printed circuit board 40 converts power supplied from the power supply section 503 to a constant voltage and supplies it to the AV printed circuit board 40.

As shown above, according to the high-definition CRT receiver 1 of this embodiment, the power supply section 503, fly-back transformer 507 and video signal processing section for deflecting electron beams of the CRT in synchronization with a color-difference signal having 1080i effective scanning lines and generating an RGB signal to be input to the CRT circuit board from the input color-difference signal having 1080i effective scanning lines are formed on the TV printed circuit board 50, while the functional sections (video signal conversion section and audio signal processing section) for generating a color-difference signal having 1080i effective scanning lines and audio signal to be input to a sound amplifier from an analog broadcasting signal or external input signal are formed on the AV printed circuit board 40 which is a circuit board different from the TV printed circuit board 50, and therefore it is possible to manufacture a variety of products at minimum development cost and manufacturing costs by replacing the AV printed circuit board 40 for generating the color-difference signal having 1080i effective scanning lines and audio signal to be input to a sound amplifier. That is, by forming functional sections common to CRT display devices (part that outputs video and audio from the color-difference signal having 1080i effective scanning lines and audio signal to be input to a sound amplifier and power supply section) on the TV printed circuit board, it is possible to develop, for example, an AV printed circuit board for generating a color-difference signal having 1080i effective scanning lines and audio signal to be input to a sound amplifier from a digital broadcasting signal, an AV printed circuit board having a circuit for improving image quality and sound quality when generating a color-difference signal having 1080i effective scanning lines and audio signal to be input to a sound amplifier from an analog broadcasting signal and an AV printed circuit board without any circuit for improving image quality and sound quality, respectively and switch between these circuit boards to provide product groups such as digital television, high-end analog television and low-end analog television. In this embodiment, the sound processor section 403 is formed on the AV printed circuit board 40 so as to provide differences in sound quality depending on the differences in the product grade, but it is also possible to form the sound processor section 403 on the TV printed circuit board to increase parts to be shared.

### Embodiment 2

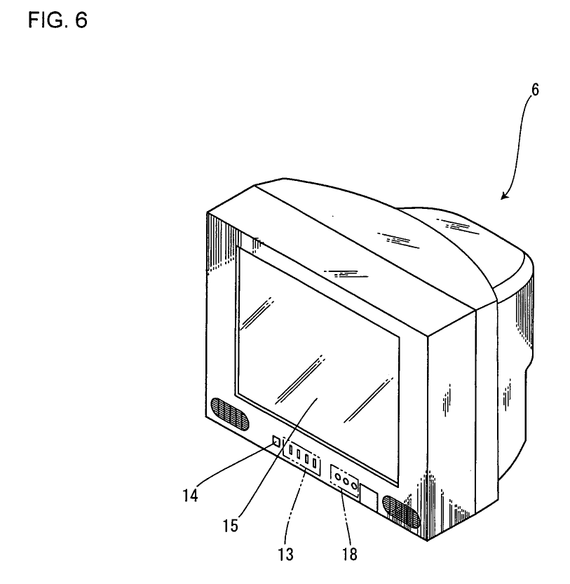

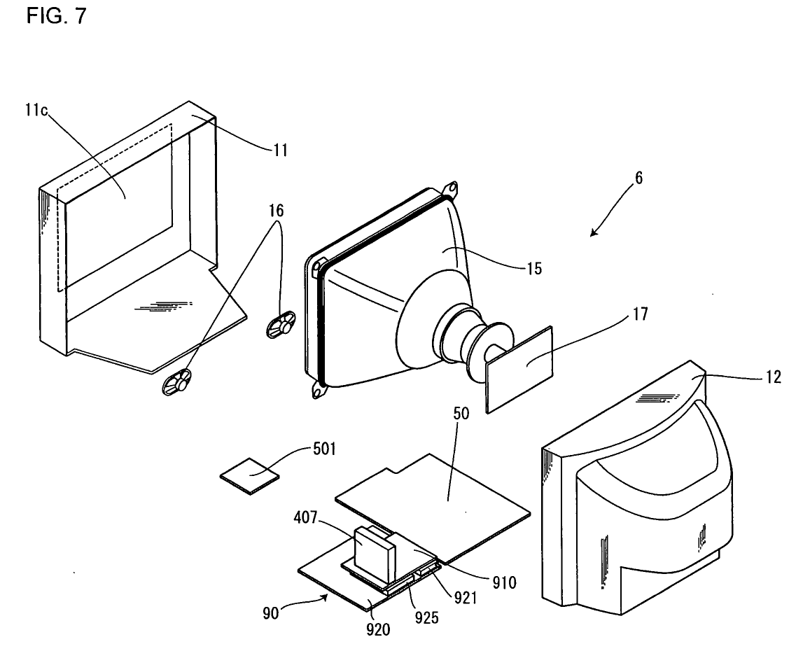

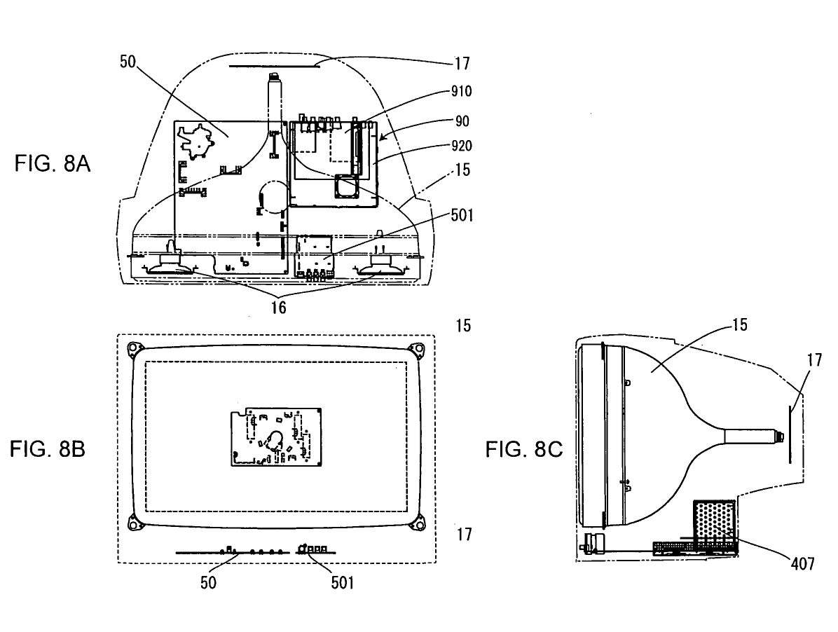

FIG. 6 is a perspective view showing a digital broadcasting CRT receiver according to this embodiment, FIG. 7 and FIG. 8 show an overview of the structure of the digital broadcasting CRT receiver; FIG. 7 is an exploded perspective view and FIG. 8 is a partial through-view of the high-definition CRT receiver; a: a top view, b: a front view and c: a side view. The same components as those in Embodiment 1 are assigned the same reference numerals as those in Embodiment 1 and detailed explanations thereof will be omitted here.

As shown in FIG. 6 to FIG. 8, the digital broadcasting CRT receiver 6 (hereinafter simply referred to as “digital CRT receiver 6”) is made up of a CRT display tube 15, a TV printed circuit board 50, an AV printed circuit board 90 and speakers 16 or the like inside a housing made up of a front cabinet 11 and a rear cabinet 12. The AV printed circuit board 90 is made up of a first circuit board 910 and a second circuit board 920 arranged one above the other. The digital broadcasting CRT receiver 6 of this embodiment has 1080i effective scanning lines.

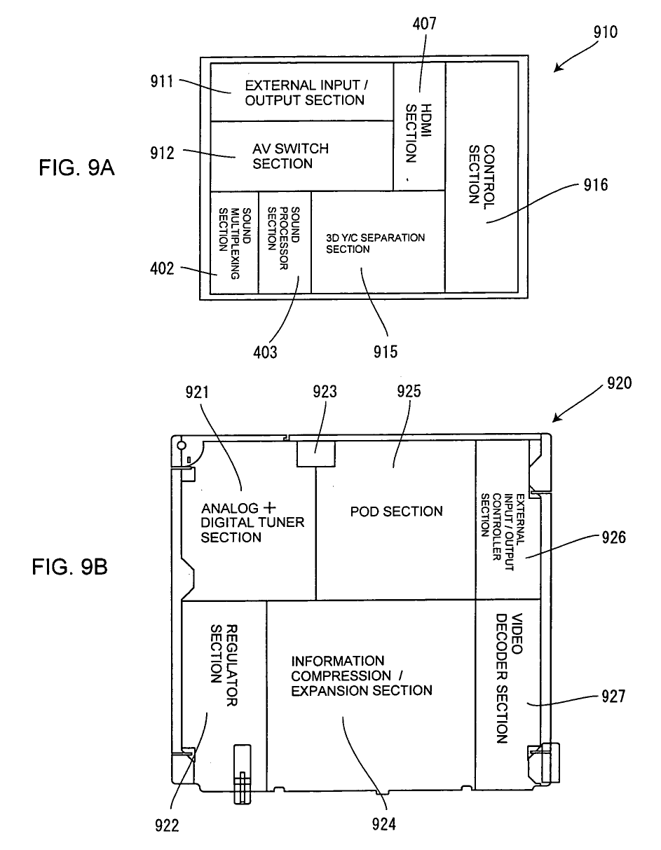

a in FIG. 9 shows a block diagram showing a schematic structure of the first circuit board 910, which makes up the AV printed circuit board 90 and b: a block diagram of the second circuit board 920. The first circuit board 910 is provided with an external input/output section 911, an AV switch section 912, a sound multiplexing section 402, a sound processor section 403, a 3DY/C separation section 915, a control section 916 and an HDMI section 407, and the second circuit board 920 is provided with an analog+digital tuner section 921, a regulator section 922, an external input/output section 923, an information compression/expansion section 924, a POD section 925, an external input/output controller section 926 and a video decoder section 927. The TV printed circuit board 50 is the same as that of Embodiment 1 (FIG. 5) and the operation of processing a color-difference signal having 1080i effective scanning lines and audio signal to be input to a sound amplifier input from the AV printed circuit board 90 is also the same and therefore explanations will be omitted here.

An overview of the operation of the AV printed circuit board 90 when a digital broadcasting signal is received will be explained. The analog+digital tuner section 921 converts an input digital broadcasting signal to a digital video audio signal. Since the digital video audio signal is in a compressed data format (MPEG format), it is input to the information compression/expansion section 924, the compressed data is restored to the original data and the color-difference signal having 1080i effective scanning lines and demodulated audio signal are extracted. The demodulated audio signal is subjected to signal processing such as sound quality adjustment and stereophonic effects by the sound processor section 403 and a audio signal to be input to a sound amplifier is created. The operations of the above described functional sections are controlled by the control section 916. Thus, the digital broadcasting signal is converted to a color-difference signal having 1080i effective scanning lines by the analog+digital tuner section 921, information compression/expansion section 924 and control section 916 which constitute the digital video signal conversion section of the AV printed circuit board 90, converted to a audio signal to be input to a sound amplifier by the analog+digital tuner section 921, information compression/expansion section 924, sound processor section 403 and control section 916 which constitute the digital sound processing section and input to the TV printed circuit board 50. The POD section 925 provided on the second circuit board 920 reads data in a PC card, the video decoder section 927 converts an analog video signal to a digital video signal and the regulator section 922 converts power supplied from the power supply section 503 to a constant voltage and supplies it to the AV printed circuit board 90.

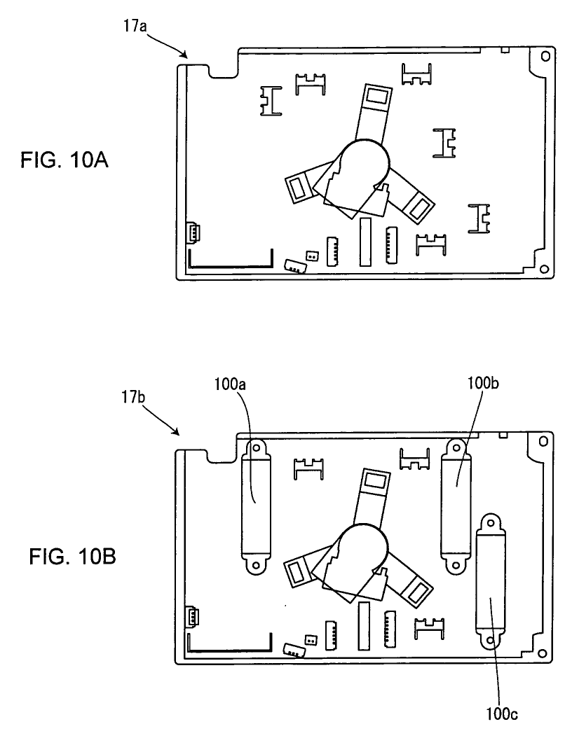

As shown above, according to the digital broadcasting CRT receiver 6 according to this embodiment, the power supply section 503, fly-back transformer 507 and video signal processing section for deflecting electron beams of the CRT in synchronization with a color-difference signal having 1080i effective scanning lines and generating an RGB signal to be input to the CRT circuit board from the input color-difference signal having 1080i effective scanning lines are formed on the TV printed circuit board 50, while the functional sections (digital video signal conversion section and digital sound processing section) for generating a color-difference signal having 1080i effective scanning lines and audio signal to be input to a sound amplifier from the digital broadcasting signal or external input signal are formed on the AV printed circuit board 90 which is a circuit board different from the TV printed circuit board 50, and therefore it is possible to manufacture a variety of products at minimum development and manufacturing costs and also increase the product development speed in the period of transition from analog television to digital television. Furthermore, as shown in FIG. 10, with regard to the circuit for amplifying a RGB signal, the CRT circuit board 17 provided in the digital CRT receiver 6 of this embodiment has a circuit board structure capable of mounting transistors 100a to 100c (since a high current flows through these transistors 100a to 100c and the amount of heat generated is also large, a large heat radiator is also provided) with an excellent high frequency characteristic amplifying a signal in response to a high frequency RGB signal as well, and therefore it is possible to share components between a CRT circuit board 17a (FIG. 10A) used for a low-end model and a CRT circuit board 17b (FIG. 10B) mounted with the transistors 100a to 100c provided with a large heat radiator used for a high-end model and provide product groups with performance differentiation at lower costs.

1. A CRT receiver which receives/displays analog broadcasting or digital broadcasting, comprising:
a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television; and
in the case of a receiver which receives analog broadcasting, an AV printed circuit board made up of one or a plurality of circuit boards including a video signal conversion section which generates the video signal from an analog broadcasting signal and a audio signal processing section which generates the audio signal from an analog broadcasting signal as a separate circuit board or
in the case of a receiver which receives digital broadcasting, an AV printed circuit board made up of one or a plurality of circuit boards including a video signal conversion section which generates the video signal from a digital broadcasting signal and a audio signal processing section which generates the audio signal from a digital broadcasting signal as a separate circuit board.

2. A CRT receiver which receives/displays analog broadcasting or digital broadcasting, comprising:
a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television; and
an AV printed circuit board made up of one or a plurality of circuit boards including a video signal conversion section which generates the video signal from an analog broadcasting signal and a audio signal processing section which generates the audio signal from an analog broadcasting signal as a separate circuit board.

3. A CRT receiver which receives/displays analog broadcasting or digital broadcasting, comprising:
a TV printed circuit board made up of one or a plurality of circuit boards including at least a power supply section which supplies power to the device, a fly-back transformer which generates a high voltage to be supplied to the CRT, a video signal processing section which deflects CRT electron beams in synchronization with an input video signal and generates an RGB signal to be input to the CRT circuit board from the input video signal and a sound amplifier section which amplifies the input audio signal, which is common to analog television and digital television; and
an AV printed circuit board made up of one or a plurality of circuit boards including a digital video signal conversion section which generates the video signal from a digital broadcasting signal and a digital audio signal processing section which generates the audio signal from a digital broadcasting signal as a separate circuit board.

4. The high-definition CRT receiver according to claim 1,
wherein the video signal processing section comprises at least, a chroma section, a horizontal drive circuit section and a vertical drive circuit section, and
the TV printed circuit board comprises an operation section provided with operation buttons and remote control light-receiving section or the like, and an external input terminal section.

5. The high-definition CRT receiver according to claim 1 or 3, wherein the video signal conversion section comprises at least an analog tuner device, a 3D Y/C separation section, an I/P conversion section, a scaler section and a control section,
the audio signal processing section comprises at least the analog tuner device, a sound multiplexing section, a sound processor section and the control section, and
the AV printed circuit board comprises an AV switch section, an A/D converter section and an external input/output terminal section.

6. The digital broadcasting CRT receiver according to claim 2 or 3, wherein the digital video signal conversion section comprises at least, a digital tuner device, an information compression/expansion section and a control section,
the digital sound processing section comprises at least the digital tuner device, the information compression/expansion section, a sound processor section and the control section, and
the AV printed circuit board comprises an AV switch section and an external input/output terminal section.

7. The digital broadcasting CRT receiver according to claim 2,
wherein the video signal processing section comprises at least, a chroma section, a horizontal drive circuit section and a vertical drive circuit section, and
the TV printed circuit board comprises an operation section provided with operation buttons and remote control light-receiving section or the like, and an external input terminal section.
